(19) United States
(12) Patent Application Publication
(10) Pub. No.: US 2014/0207426 A1
(43) Pub. Date: Jul. 24, 2014

(54) SIMULATION OF PHENOMENA CHARACTERIZED BY PARTIAL DIFFERENTIAL EQUATIONS

(71) Applicant: The Board of Trustees of the Leland Stanford Junior University, (US)

(72) Inventors: Wonseok Shin, Menlo Park, CA (US); Shanhui Fan, Stanford, CA (US)

(73) Assignee: The Board of Trustees of the Leland Stanford Junior University, Palo Alto, CA (US)

(21) Appl. No.: 13/744,999

(22) Filed: Jan. 18, 2013

(51) Int. Cl. G06F 17/50

(52) U.S. Cl. CPC G06F 17/5009
USPC 703/2

(57) ABSTRACT

Various aspects of the present disclosure are directed toward apparatus, methods, and articles of manufacture for simulating a physical phenomenon characterized by a set of partial differential equations that are reduced based on harmonic time dependence. The system of linear equations represent an operation in the differential equations, and are characterized by a coefficient matrix multiplied by an unknown column vector, with the product thereof being equal to a column vector. The system of linear equations is solved using at least one of three sets of operations.

### BACKGROUND

Simulating a physical phenomenon is useful in analyzing and the behavior of physical phenomenon that cannot be easily measured or observed. One such simulation approach involves solving equations, such as Maxwell's equations, that can be used to characterize the phenomenon (e.g., as relative to a system). These approaches have been useful in a variety of fields and applications, such as those related to electrodynamics, optics and electrical applications.

While such approaches have been very useful, there have been many challenges to properly implementing the approaches, and to doing so in an efficient manner. For instance, computational burdens can limit the usefulness of such simulations, requiring a great deal of processing power and limiting the use of such simulations in the field. Further, the time to effect simulation can be undesirably long. These and other issues have presented challenges in these and other applications.

### SUMMARY

Aspects of the present disclosure are directed toward apparatuses, methods, and articles of manufacture for simulating a physical phenomenon characterized by a set of partial differential equations that are reduced based on harmonic time dependence. Included in these aspects are, for example, a data computing circuit having a stored system of linear equations representing an operation in the differential equations. The system of linear equations is characterized by a coefficient matrix multiplied by an unknown column vector, with the product thereof being equal to a column vector. Also stored therein on the data computing circuit is a program for executing an algorithm which, when executed, solves the system of linear equations. The system of linear equations is solved using at least one of three sets of operations.

The first set of operations includes multiplying the coefficient matrix by left and right scale-factor preconditioning matrices, and multiplying the column vector by the left scale-factor preconditioning matrix. In this first set of operations, each matrix includes entries of scale factors or combinations of scale factors of a perfectly matched layer. The second set of operations includes symmetrizing the coefficient matrix by multiplying the coefficient matrix by left and right diagonally-dominant preconditioning matrices while maintaining a condition number of the coefficient matrix within an order of magnitude of a condition number of the matrix prior to symmetrizing. The third set of operations includes confining a majority of eigenvalues of the coefficient matrix in a half-plane having a boundary that crosses an origin of a complex plane.

The above discussion is not intended to describe each embodiment or every implementation. The figures and following description also exemplify various embodiments.

### BRIEF DESCRIPTION OF FIGURES

Various example embodiments may be more completely understood in consideration of the following detailed description in connection with the accompanying drawings, in which:

FIG. 1 shows an example module-level diagram of a data computing circuit, consistent with various aspects of the present disclosure;

FIG. 2 shows an example of a metallic slot waveguide bend, consistent with various aspects of the present disclosure;

FIG. 3 shows the convergence behavior of the preconditioning scheme tailored for UPML, consistent with various aspects of the present disclosure;

FIG. 4 shows an example convergence behavior utilizing a quasi-minimal residual (QMR) approach for non-symmetric and symmetric coefficient matrices, consistent with various aspects of the present disclosure; and

FIG. 5 shows an example convergence behavior of elimination of the high multiplicity of non-zero eigenvalues for different values, consistent with various embodiments of the present disclosure.

While the disclosure is amenable to various modifications and alternative forms, examples thereof have been shown by way of example in the drawings and will be described in detail. It should be understood, however, that the intention is not to limit the disclosure to the particular embodiments shown and/or described. On the contrary, the intention is to cover all modifications, equivalents, and alternatives falling within the spirit and scope of the disclosure.

### DETAILED DESCRIPTION

Aspects of the instant disclosure are directed towards apparatus, methods, and articles of manufacture useful in simulating a physical phenomenon characterized by a set of partial differential equations that are reduced based on harmonic time dependence. The set of partial differential equations (e.g., Maxwell's equation) can be used to analyze systems that involve electromagnetism (EM), optical phenomena, or other areas of physics (e.g., acoustics, fluid dynamics) that can be modeled as differential equations governing wave-like phenomena. Although the discussion of this simulation focuses on an apparatus, methods are also provided to execute the simulation. Further, aspects of the present disclosure are also directed towards articles of manufacture designed to carry out the steps of these methods through a processor arrangement.

Certain aspects of the present disclosure are directed towards simulating a physical phenomenon characterized by a set of partial differential equations that are reduced based on harmonic time dependence. The reduction of a partial set of differential equations allows for simplifying the amount of data needed to be solved by assuming that the equations are time dependent. A data computing circuit is provided to store a system of linear equations representing an operation in the differential equations in which a coefficient matrix is multiplied by an unknown column vector, with the product of this multiplication being equal to a column vector. Also stored in the data computing circuit is a program for executing an algorithm which, when executed, solves the system of linear equations. The algorithm sets forth multiple sets of operations in order to solve the system of linear equations. The first set of operations includes multiplying the coefficient matrix by left and right scale-factor preconditioning matrices, and multiplying the column vector by the left scale-factor preconditioning matrix. In the first set of operations, each matrix includes entries of scale factors (or combinations of scale factors) of a perfectly matched layer. The second set of operations includes symmetrizing the coefficient matrix by multiplying the coefficient matrix by left and right diagonally-dominant preconditioning matrices while maintaining a condition number of the coefficient matrix within an order of magnitude of a condition number of the matrix prior to symmetrizing. In certain embodiments, symmetrizing the coefficient matrix includes preserving diagonal elements of the coefficient matrix. The third set of operations includes confining a majority of eigenvalues of the coefficient matrix in a half-plane having a boundary that crosses an origin of a complex plane.

Certain more specific embodiments of the present disclosure include executing two or even three of the set of operations to solve the system of linear equations. In embodiments executing two or three of the sets of operations, the algorithm can set forth the operation of confining the majority of eigenvalues of the coefficient matrix in the half-plane, and thereafter, the operation at least one of the steps of multiplying the coefficient matrix by the left and right scale-factor preconditioning matrices and symmetrizing the coefficient matrix.

In certain more specific aspects of an apparatus, consistent with various embodiments of the present disclosure, the data computing circuit is configured and arranged to receive data characterizing the physical phenomenon. Using the received data as an input, the program is then used to execute the algorithm, solve the system of linear equations through at least one of the set of operations described above, and generate an output that characterizes the physical phenomenon.

Various types of physical phenomena are simulated or otherwise characterized, in connection with one or more embodiments. For instance, embodiments of the apparatus having these attributes can also be further characterized in that the data computing circuit executes the algorithm to solve the linear equations by executing the algorithm with received electromagnetic wave data to solve the linear equations, and generating an output that characterizes the behavior of the electromagnetic wave. In other embodiments, the algorithm is executed with received optical wave data to solve the linear equations and generate an output that characterizes behavior of the optical wave. In other embodiments, the data computing circuit executes the algorithm with received fluid dynamics system data to solve the linear equations and generate an output that characterizes behavior of the fluid dynamics system. Other embodiments are directed to executing the algorithm with received chemical reaction data to solve the linear equations and generate an output that characterizes behavior of the chemical reaction. In still other embodiments, the data computing circuit executes the algorithm with received mechanical system data to solve the linear equations and generate an output that characterizes behavior of the mechanical system.

Embodiments of an apparatus, consistent with various aspects of the present disclosure, are further characterized in that multiplying the coefficient matrix by the left and right scale-factor preconditioning matrices includes utilizing the left and right scale-factor preconditioning matrices Pₗ and Pᵣ, in which:

$${P}_{l} = [ \begin{matrix}⋱ & & & & \\ & {s}_{y}^{j} {s}_{z}^{k} & & & \\ & & {s}_{z}^{k} {s}_{x}^{i} & & \\ & & & {s}_{x}^{i} {s}_{y}^{j} & \\ & & & & ⋱\end{matrix} ]$$

$${P}_{r} = [ \begin{matrix}⋱ & & & & \\ & 1 \text{/} {s}_{x}^{i + 1 \text{/} 2} & & & \\ & & 1 \text{/} {s}_{y}^{j + 1 \text{/} 2} & & \\ & & & 1 \text{/} {s}_{z}^{k + 1 \text{/} 2} & \\ & & & & ⋱\end{matrix} ]$$

Additionally, the left and the right diagonally-dominant preconditioning matrices (Pₗ and Pᵣ) are, in certain embodiments, shown to be:

$${P}_{l} = [ \begin{matrix}⋱ & & & & \\ & \frac{1}{\sqrt{\text{?} \text{?} \text{?}}} & & & \\ & & \frac{1}{\sqrt{\text{?} \text{?} \text{?}}} & & \\ & & & \frac{1}{\sqrt{\text{?} \text{?} \text{?}}} & \\ & & & & ⋱\end{matrix} ]$$

$${P}_{r} = [ \begin{matrix}⋱ & & & & \\ & \sqrt{\text{?} \text{?} \text{?}} & & & \\ & & \sqrt{\text{?} \text{?} \text{?}} & & \\ & & & \sqrt{\text{?} \text{?} \text{?}} & \\ & & & & ⋱\end{matrix} ] . \\ \text{?} \text{indicates text missing or illegible when filed}$$

In certain embodiments, the third set of operations that utilize confining of a majority of eigenvalues of the coefficient matrix also include shifting eigenvalues that are outside the half-plane, into the half-plane by modifying the coefficient matrix. More specifically, various embodiments include shifting of at least 75%, 90% or even up to 95% of the eigenvalues. Further, confining a majority of eigenvalues of the coefficient matrix can include shifting eigenvalues, which are outside the half-plane, into the half-plane by modifying the coefficient matrix by utilizing a constant s=−1 in connection with Equation 13 herein.

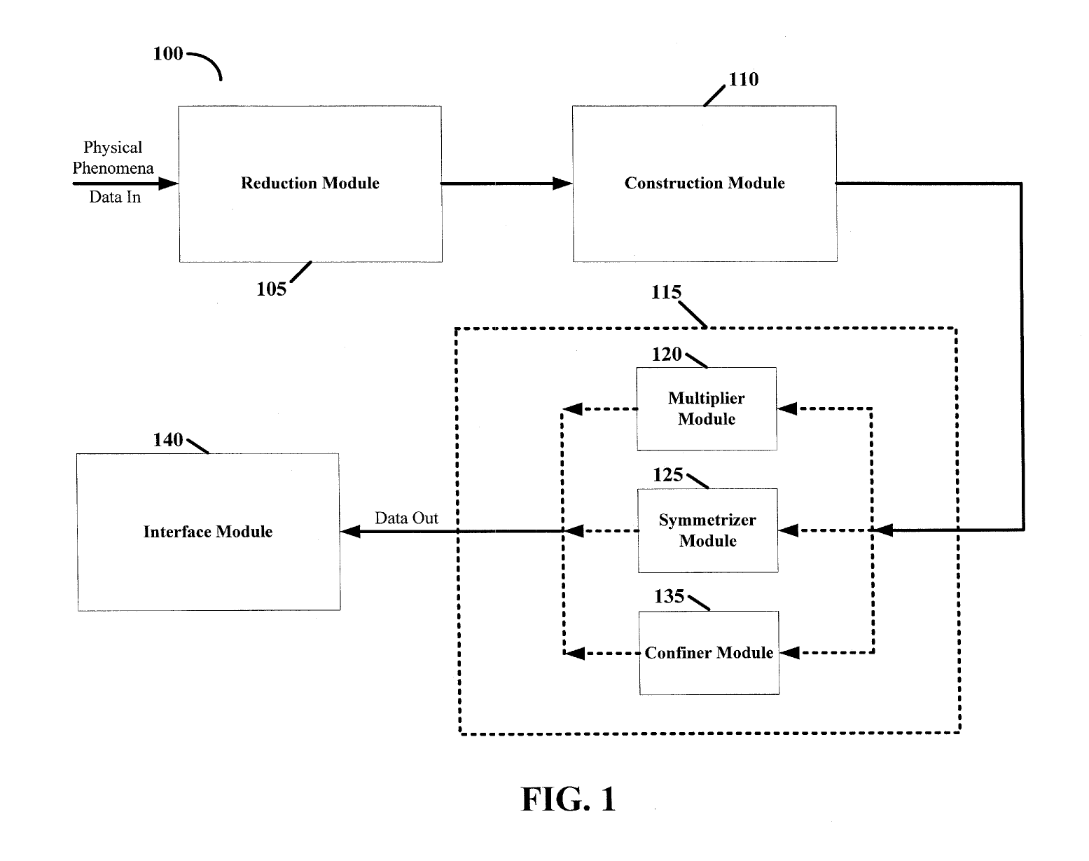

Turning now to the figures, FIG. 1 shows an example module-level diagram of a data computing circuit 100, consistent with various aspects of the present disclosure. As shown in FIG. 1, data computing circuit 100 includes various different modules, including a reduction module 105, construction module 110, solver module 115, multiplier module 120, symmetrizer module 125, confiner module 135 and interface module 140. One or more of these respective modules can be implemented separately or together, in connection with various example embodiments. The reduction module 105 reduces a set of partial differential equations based upon harmonic time dependence. The data computing circuit stores a system of differential equations representing an operation in the differential equations, with the operation including a coefficient matrix multiplied by an unknown column vector, and with the product of that multiplication being equal to a column vector. The construction module 110 constructs a system of linear equations from the reduced set of partial differential equations.

The solver module 115 solves the system of linear equations by utilizing one or more of three sets of operations. The three sets of operations are carried out, in the data computer circuit 100, by the multiplier module 120, symmetrizer module 125, and confiner module 135. In some embodiments, the data computing circuit 100 includes fewer than all of the multiplier, symmetrizer and confiner modules. The multiplier module 120 multiplies the coefficient matrix by left and right scale-factor preconditioning matrices, and by multiplying the column vector by the left scale-factor preconditioning matrix. Each matrix includes entries of scale factors (or combinations of scale factors) of a perfectly matched layer. The symmetrizer module 125 symmetrizes the coefficient matrix by multiplying the coefficient matrix by left and right diagonally-dominant preconditioning matrices, while maintaining a condition number of the coefficient matrix within an order of magnitude of a condition number of the matrix prior to symmetrizing. In certain embodiments, the symmetrizer module 125 also maintains diagonal elements of the coefficient matrix, in the multiplication. The confiner module 135 confines a majority of eigenvalues of the coefficient matrix in a half-plane having a boundary that crosses an origin of a complex plane. Each of the multiplier module 120, the symmetrizer module 125, and the confiner module 135 provides an output of the solved system of linear equations. These respective multiplier, symmetrizer and confiner modules may, for example, be carried out using one or more approaches described further herein, in connection with the above-referenced multiplying, symmetrizing and confining operations.

One or more of the outputs of the multiplier module 120, the symmetrizer module 125, and the confiner module 135 are used together, in connection with certain embodiments. For instance, the data computer circuit 100 can execute the operations of one, two, or all of the multiplier module 120, the symmetrizer module 125, and the confiner module 135 in solving the system of linear equations. In certain embodiments, an algorithm stored on the data computing circuit 100 first utilizes the confiner module 135, then uses one or both of the multiplier module 120 and the symmetrizer module 125, in solving the system of linear equations.

In certain more specific embodiments, the data computing circuit 100 is configured and arranged to receive data (as shown by data in input to the reduction module 105) characterizing a physical phenomenon. This data may, for example, include user-provided data or inputs, and/or data relating to a system. Using the received data as an input, the system of linear equations is solved through at least one of the set of operations described above. As a result of this, the solver module 115 generates an output that characterizes the physical phenomenon, and provides the output to the interface module 140. The interface module 140 is provided, in certain specific embodiments, to further analyze the data (e.g., by an output of the raw data; an output in a graphical or visual format). Such physical phenomena that may be characterized in this manner include, for example, electromagnetic phenomenon, optical phenomenon, fluid dynamic phenomenon, chemical phenomenon, and mechanical phenomenon.

The confiner module 135 operates to facilitate solving of the equations using one or more of a variety of approaches. In some embodiments, the confiner module 135 confines a majority of eigenvalues of the coefficient matrix in a half-plane having a boundary that crosses an origin of a complex plane. The confiner module 135, in certain embodiments, confines a majority of eigenvalues of the coefficient matrix by shifting eigenvalues, which are outside the half-plane, into the half-plane by modifying the coefficient matrix. In some embodiments, the confiner module 135 shifts at least 75%, 90% or even up to 95% of the eigenvalues. Additionally, the confiner module 135, in certain embodiments shifts the eigenvalues into the half-plane by modifying the coefficient matrix, by utilizing a constant s=−1 in connection with Equation 13 herein.

In certain embodiments, the multiplier module 120 multiplies the coefficient matrix by the left and right scale-factor preconditioning matrices, utilizing left and right scale-factor preconditioning matrices Pₗ and Pᵣ, in which:

$${P}_{l} = [ \begin{matrix}⋱ & & & & \\ & {s}_{y}^{j} {s}_{z}^{k} & & & \\ & & {s}_{z}^{k} {s}_{x}^{i} & & \\ & & & {s}_{x}^{i} {s}_{y}^{j} & \\ & & & & ⋱\end{matrix} ]$$

$${P}_{r} = [ \begin{matrix}⋱ & & & & \\ & 1 \text{/} {s}_{x}^{i + 1 \text{/} 2} & & & \\ & & 1 \text{/} {s}_{y}^{j + 1 \text{/} 2} & & \\ & & & 1 \text{/} {s}_{z}^{k + 1 \text{/} 2} & \\ & & & & ⋱\end{matrix} ] .$$

Additionally, in various embodiments, the symmetrizer module 125 utilizes left and the right diagonally-dominant preconditioning matrices (Pₗ and Pᵣ):

$${P}_{l} = [ \begin{matrix}⋱ & & & & \\ & \frac{1}{\sqrt{\text{?} \text{?} \text{?}}} & & & \\ & & \frac{1}{\sqrt{\text{?} \text{?} \text{?}}} & & \\ & & & \frac{1}{\sqrt{\text{?} \text{?} \text{?}}} & \\ & & & & ⋱\end{matrix} ]$$

$${P}_{r} = [ \begin{matrix}⋱ & & & & \\ & \sqrt{\text{?} \text{?} \text{?}} & & & \\ & & \sqrt{\text{?} \text{?} \text{?}} & & \\ & & & \sqrt{\text{?} \text{?} \text{?}} & \\ & & & & ⋱\end{matrix} ] . \\ \text{?} \text{indicates text missing or illegible when filed}$$

A specific discussion of an example simulation of a physical phenomenon characterized by a set of partial differential equations is beneficial for a further understanding of various aspects of the present disclosure. In the below discussion, an electromagnetic physical phenomenon is characterized by Maxwell's equations. However, such an approach may be applicable to characterizing a variety of types of physical phenomenon, such as those described herein.

In such an example embodiment, Maxwell's equations are simplified (e.g., reduced) by assuming a time dependence (e^{+iωt}). By this assumption, Maxwell's equations are reduced to:

∇×μ⁻¹∇×E−ω²εE=−iωJ, (1)

where ε is the electric permittivity; μ is the magnetic permeability, ω is the angular frequency; E, H, and J are the electric field, magnetic field, and the electric current source density, respectively.

To solve Equation 1, the result of a reduction of Maxwell's equations, methods such as finite-difference frequency-domain (FDFD) or finite element method (FEM) can be used to construct a system of linear equations:

Ax=b, (2)

where A is a coefficient matrix representing the operator [∇×(μ⁻¹∇×)−ω²ε];
x is an unknown column vector representing E; and b is a column vector representing −iωJ. The coefficient matrix A constructed is large (e.g., greater than 10 million rows and columns in a 3-dimensional problem) and sparse (e.g., 13 non-zero elements per row when generated by the FDFD method). In order to solve such a system of equations, iterative methods utilize a step-by-step sequence of approximations of solution to the system of equations that converges based on a termination criterion. Direct methods of solving a system of equations, on the other hand, utilize a finite sequence of operations to deliver an exact solution. In systems of equations having large numbers of unknown variables, it may be advantageous to utilize an iterative method of solving the equation due to the large computing power necessary to directly solve such a system of equations. However, various embodiments are directed to using a direct solver, while other embodiments use such an iterative approach.

In this example, the system of linear equations is solved by converging upon a solution using an iterative solver to converge (with the understanding that a direct approach may also be used). Accordingly, various sets of operations consistent with the instant disclosure accelerate the solving of Maxwell's equations using an iterative method or direct method. Acceleration of convergence is desirable as a cost saving on computing power, and to facilitate the ability to run multiple simulations over a shorter period of time.

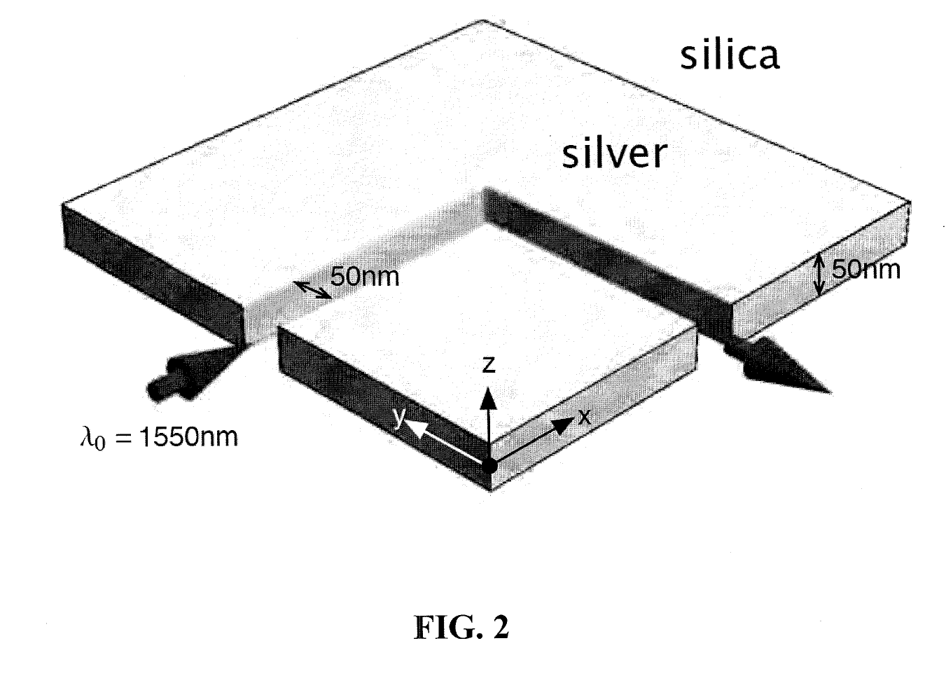

The specific example application of solving an electromagnetic (EM) system is shown by simulation of an EM wave propagating through a metallic slot waveguide having a 90 degree bend. FIG. 2 shows an example of a metallic slot waveguide bend, consistent with various aspects of the present disclosure. In the example shown in FIG. 2, a narrow slot is formed between two pieces of the thin silver (Ag) immersed in a background of silica (SiO₂). The waveguide is bent 90 degrees. The arrows specify the directions of wave propagation.

In solving a simulation of such an EM system, it is useful to first construct a system of linear equations (such as Equation 2 above), that is representative of the reduced Maxwell's equations (Equation 1 above). In certain embodiments, an FDFD method is utilized on a non-uniform grid (e.g., with cell sizes that vary from 2 nm to 2 nm) that represents the metallic slot waveguide having a 90 degree bend. The number of grid cells in the simulation domain is equal to Nₓ×N_{y}×N_{z} (192×192×240). The grid cells are elements to be solved for in the system of linear equations. Thus, because the grid cells would be represented as a column vector x in accordance with Equation 2, the number of unknowns in the column vector x would be 3 times Nₓ×N_{y}×N_{z} (approximately 26.5 million unknowns). Accordingly, due to the large number of unknowns, an iterative method of solving the system can be implemented to achieve greater efficiency than utilizing a direct method.

In various embodiments, an iterative method known as the quasi-minimal residual (QMR) method is used to solve the systems of linear equations throughout the present disclosure. Aspects of the present disclosure are utilized to accelerate convergence of the QMR method, and certain aspects are useful in accelerating convergence of other types of iterative methods such as the biconjugate Gradient Method, the Biconjugate Gradient Stabilized Method, Chebyshev Iteration, the Conjugate Gradient Method, the Conjugate Gradient Method on the Normal Equations, the Conjugate Gradient Squared Method, the Flexible Generalized Minimal Residual Method, the Generalized Minimal Residual Method, the Minimal Residual Method, the Nonstationary Iterative Method, the Stationary Iterative Method, the Symmetric LQ Method, and the Transpose-Free Quasi-Minimal Residual Method.

Certain aspects of the present disclosure utilize a uniaxial perfectly matched layer (UPML) boundary condition in the simulation of infinite space. A UPML is implemented by modifying the reduced Maxwell's equation (Equation 1) to:

$$\begin{matrix}∇ \times {( {{μ}^{=}}_{s} )}^{- 1} ∇ \times E - {ω}^{2} {{ɛ}^{=}}_{s} E = iω J , \\ where & ( 3 ) \\ {{ɛ}^{=}}_{s} = ɛ [ \begin{matrix}\frac{{s}_{y} {s}_{z}}{{s}_{x}} & 0 & 0 \\ 0 & \frac{{s}_{z } {s}_{x}}{{s}_{y}} & 0 \\ 0 & 0 & \frac{{s}_{x} {s}_{y}}{{s}_{z}}\end{matrix} ] , {{μ}^{=}}_{s} = μ [ \begin{matrix}\frac{{s}_{y} {s}_{z}}{{s}_{x}} & 0 & 0 \\ 0 & \frac{{s}_{z} {s}_{x}}{{s}_{y}} & 0 \\ 0 & 0 & \frac{{s}_{x} {s}_{y}}{{s}_{z}}\end{matrix} ] . & ( 4 )\end{matrix}$$

In Equation 4, perfectly matched layer (PML) scale factors s_{w} for w=x, y, z are

$${s}_{w} ( l ) = \{ \begin{matrix}1 - {is}_{w}^{″} ( l ) & inside the w - normal PML , \\ 1 & elsewhere ,\end{matrix} \qquad ( 5 )$$

where l is the depth measured from the w-normal PML interface; ε₀ is the electric permittivity of vacuum; s_{w}″(l) is a function that increases with l from 0 to a value typically much larger than 1.

Use of the UPML, however, makes the coefficient matrix A, in the system of linear equations that result from the reduced Maxwell's equation, ill-conditioned. An ill-conditioned coefficient matrix A slows the convergence of iterative solvers. In order to enhance the convergence speed, preconditioning a system of linear equations (Equation 2) representative of reduced Maxwell's equation (Equation 1) utilize left (Pₗ) and right (Pᵣ) preconditioning matrices, in accordance with one or more embodiments herein (e.g., and as may be implemented as shown in FIG. 1). Preconditioning the system of linear questions includes multiplying the left (Pₗ) and right (Pᵣ) preconditioning matrices as follows:

(Pₗ⁻¹APᵣ⁻¹)y=Pₗ⁻¹b (6)

where A is the coefficient matrix, y is the unknown column vector, and b is a known column vector. Equation 6 is solved for y utilizing an iterative method, and the original solution of Equation 2 will be recovered as x=Pᵣ⁻¹y.

Certain aspects of the present disclosure are directed to a preconditioning scheme tailored for UPML. To demonstrate the preconditioning scheme tailored for UPML, an arbitrary electric field E is represented as a column vector e. On the finite-difference grid, the x-, y-, z-components of E are denoted by Eₓ^{i+1/2,j,k}, E_{y}^{i+1/2,j,k}, E_{z}^{i+1/2,j,k}, respectively (superscripts are the grid indices). Using this notation, e is represented as:

e=[ . . . Eₓ^{i+1/2,j,k}E_{y}^{i+1/2,j,k}E_{z}^{i,j,k+1/2} . . . ]^{T}. (7)

Left and the right preconditioners (Pₗ and Pᵣ), which are shown as applied to the electric field column vector e, are implemented as follows:

$$\begin{matrix}{P}_{l} e = [ \begin{matrix}⋱ & & & & \\ & {s}_{y}^{i} {s}_{z}^{k} & & & \\ & & {s}_{z}^{k} {s}_{x}^{i} & & \\ & & & {s}_{x}^{i} {s}_{y}^{j} & \\ & & & & ⋱\end{matrix} ] [ \begin{matrix}⋮ \\ {E}_{x}^{i + 1 \text{/} 2 , j , k} \\ {E}_{y}^{i , j + 1 \text{/} 2 , k} \\ {E}_{z}^{i , j , k + 1 \text{/} 2} \\ ⋮\end{matrix} ] & ( 8 ) \\ {P}_{r} e = [ \begin{matrix}⋱ & & & & \\ & 1 \text{/} {s}_{x}^{i + 1 \text{/} 2} & & & \\ & & 1 \text{/} {s}_{y}^{j + 1 \text{/} 2} & & \\ & & & 1 \text{/} {s}_{z}^{k + 1 \text{/} 2} & \\ & & & & ⋱\end{matrix} ] [ \begin{matrix}⋮ \\ {E}_{x}^{i + 1 / 2. j , k} \\ {E}_{y}^{i , j + 1 / 2 , k} \\ {E}_{z}^{i , j , k + 1 / 2} \\ ⋮\end{matrix} ] . & ( 9 )\end{matrix}$$

As shown in Equations 8 and 9, the left and right preconditioning (Pₗ and Pᵣ), consistent with various aspects of the present disclosure, are diagonal matrices.

In certain embodiments, FEM is used to discretize Equation 1, rather than the FDFD method. In these instances, Pₗ and Pᵣ can include up to three non-zero elements per row. The elements of the column vector e do not necessarily correspond to Cartesian components of E. However, by choosing the mesh inside the PML, the preconditions for FEM can also be diagonal.

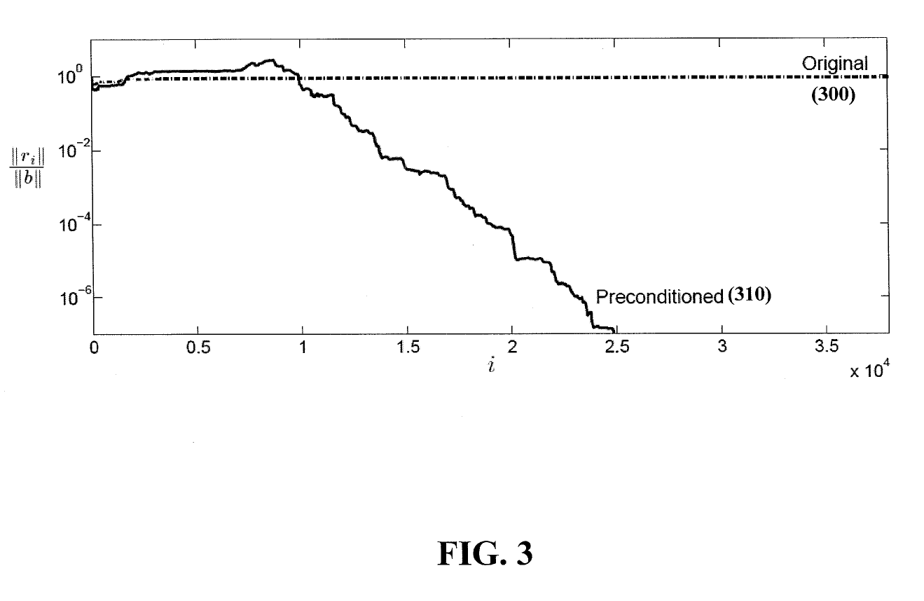

FIG. 3 shows the convergence behavior of the preconditioning scheme tailored for UPML, consistent with various aspects of the present disclosure. FIG. 3 shows that the preconditioning scheme tailored for UPML (310) converges after approximately 2.5×10⁴ iterations in solving the metallic slot waveguide bend utilizing QMR. FIG. 3 also shows use of QMR to solve the metallic slot waveguide bend without the preconditioning scheme tailored for UPML (310). As shown therein, the non-preconditioned QMR does not converge in the number of iterations shown in FIG. 3.

Certain aspects of the present disclosure are also directed toward a preconditioning scheme that focuses on transforming the original coefficient matrix A, of the system of linear equations constructed from the reduced Maxwell's equations, into a symmetric matrix as follows. In constructing the system of linear equations, the coefficient matrix A is created directly based from the operator of Equation 1. The operator, as referenced above, is non-symmetric (i.e., A^{T}≠A) when the operator is discretized on a non-uniform grid, and is symmetrized to address issues such as those relating to computational requirements and others for non-symmetric operators. The non-symmetric coefficient matrix A is modified into a symmetric matrix that is as well-conditioned as the original coefficient matrix A. The singular values of a matrix (such as the coefficient matrix A) determine whether a matrix is well-conditioned. The conditioning of a matrix, often associated with a condition number, is associated with the accuracy of a solution to a system of linear equations (e.g., Equation 2).

Symmetrizing a non-symmetric matrix may not lead to faster convergence. For example, if modifying a non-symmetric coefficient matrix A into a symmetric matrix that is not as well-conditioned as the original coefficient matrix A, even though the number of iterations is halved, the result will be a worse-conditioned coefficient matrix on a non-uniform grid. Because the matrix is worse-conditioned than the original coefficient matrix, the number of steps and iterations for convergence will be greater than if the original coefficient matrix was used to solve the linear system of equations. Accordingly, aspects of the present disclosure operate on the discovery/recognition that modifying the non-symmetric coefficient matrix A into a symmetric matrix (that is as well-conditioned as the original coefficient matrix A) will accelerate convergence of an iterative solver.

An example embodiment of the preconditioning scheme of symmetrizing the non-symmetric coefficient matrix A is shown with reference to a column vector e, which represents an arbitrary electric field E. The left and right preconditioners Pₗ and Pᵣ are shown as multiplied by the column vector e:

$$\begin{matrix}{P}_{l} e = [ \begin{matrix}⋱ & & & & \\ & \frac{1}{\sqrt{\text{?} \text{?} \text{?}}} & & & \\ & & \frac{1}{\sqrt{\text{?} \text{?} \text{?}}} & & \\ & & & \frac{1}{\sqrt{\text{?} \text{?} \text{?}}} & \\ & & & & ⋱\end{matrix} ] [ \begin{matrix}⋮ \\ {E}_{x}^{i + 1 / 2 , j , k} \\ {E}_{y}^{i , j + 1 / 2 , k} \\ {E}_{z}^{i , j , k + 1 / 2} \\ ⋮\end{matrix} ] & ( 10 ) \\ {P}_{r} e = [ \begin{matrix}⋱ & & & & \\ & \sqrt{{Δ}_{x}^{1 + 1 \text{/} 2} {Δ}_{y}^{j} {Δ}_{z}^{k}} & & & \\ & & \sqrt{\text{?} {Δ}_{y}^{j + 1 \text{/} 2} {Δ}_{z}^{k}} & & \\ & & & \sqrt{{Δ}_{x}^{i} {Δ}_{y}^{j} {Δ}_{z}^{k + 1 \text{/} 2}} & \\ & & & & ⋱\end{matrix} ] . \\ \text{?} \text{indicates text missing or illegible when filed} & ( 11 )\end{matrix}$$

In embodiments of the present disclosure that utilize left and right preconditioners Pₗ and Pᵣ shown in Equations 10 and 11, the resulting symmetric preconditioned matrix is:

A_{sym}=Pₗ⁻¹APᵣ⁻¹ (12)

In certain embodiments of the present disclosure that utilize a precondition scheme including the left and right preconditioners Pₗ and Pᵣ in Equations 10 and 11, the diagonal elements of the coefficient matrix A are preserved. The original coefficient matrix A is generally diagonally dominant, and therefore, the presently discussed preconditioning scheme does not severely change how conditioning of the coefficient matrix A.

In order to illustrate the aspects of the present disclosure that utilize a precondition scheme including the left and right preconditioners Pₗ and Pᵣ shown in Equations 10 and 11, the system of linear equations (Equation 2) are solved utilizing the iterative QMR method. The convergence speed is demonstrated by comparing a preconditioned system of linear equations solved versus a system of linear equations that is not preconditioned. Both are solved utilizing the iterative QMR method.

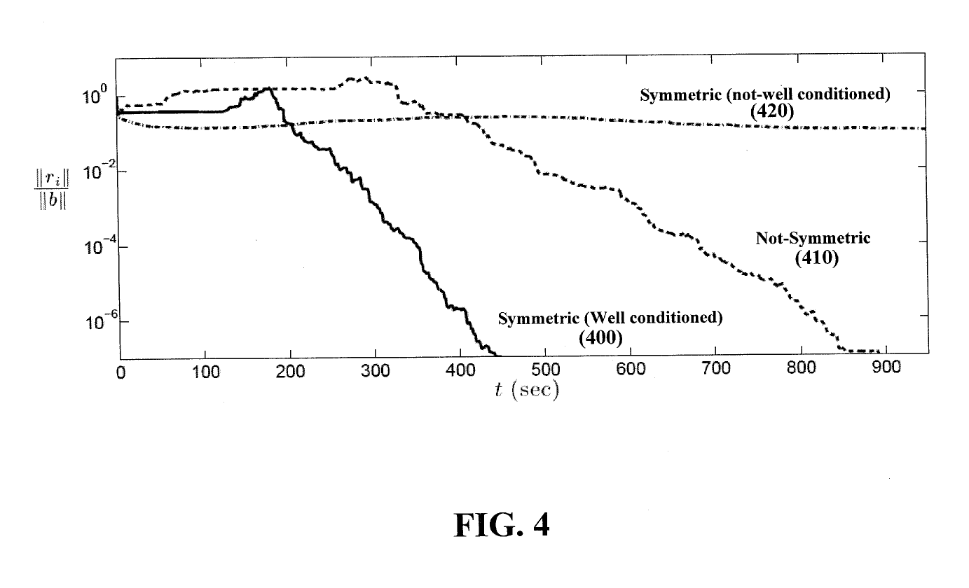

FIG. 4 shows an example convergence behavior utilizing QMR for non-symmetric and symmetric coefficient matrices, consistent with various aspects of the present disclosure. FIG. 3 shows a plot of the resulting ∥rᵢ∥/∥b∥ versus the cumulative computation time for solving the metallic slot wavelength guide bend described above. FIG. 4 shows the computation time for the symmetric preconditioning scheme (400), consistent with various aspects of the present disclosure, for a non-symmetric matrix (410) and a symmetric matrix (420) that is not as well conditioned as the original coefficient matrix A. As shown in FIG. 4, the convergence of the symmetric preconditioning scheme (400), consistent with various aspects of the present disclosure, is nearly twice as fast as a scheme utilizing a non-symmetric matrix (410). Further, the convergence of a scheme that utilizes a symmetric matrix that is not as well conditioned as the original coefficient matrix A (420) cannot be shown as converging within the time bounds of FIG. 4.

Certain aspects of the present disclosure are directed toward elimination of the high multiplicity of non-zero eigenvalues in the coefficient matrix A in solving a system of linear equations by an iterative method. For instance, convergence of an iterative method to solve the reduced Maxwell's equation (Equation 1) can be slow in the “low-frequency” regime where the wavelength in the simulation domain is much longer than the grid cell size A. In certain embodiments, high multiplicity of non-zero eigenvalues in the operator of Equation 1 is removed, and thus convergence is accelerated, by modifying Equation 1 into:

$$∇ \times {μ}^{- 1} ∇ \times E + s ∇ [ {( μ \text{?} )}^{- 1} ∇ \cdot ( \text{?} E ) ] - {ω}^{2} \text{?} = - iω J + s \frac{i}{ω} ∇ [ {( μ \text{?} )}^{- 1} ∇ \cdot J ] , \\ \text{?} \text{indicates text missing or illegible when filed} \qquad ( 13 )$$

where s is an arbitrary constant. Equation 13 is obtained when the continuity equation (Equation 14) is manipulated appropriately and then added to Equation 1. The continuity equation is shown as:

$$∇ \cdot ( ɛ E ) = \frac{1}{ω} ∇ \cdot J \qquad ( 14 )$$

Equation 13 reduces to Equation 1 when s=0. Because the continuity equation (Equation 14) is derived by taking the divergence of (1), the solution of Equation 13 is the same as the solution of Equation 1 (reduced Maxwell's equation). The properties of the operator of Equation 13 can vary with s. The convergence behavior of iterative methods greatly depends on the properties of the coefficient matrix A, therefore, different values of s are used to lead to different convergence speeds of iterative methods. For instance, in certain embodiments of the present disclosure, a value of s=−1 allows for the elimination of the high multiplicity of non-zero eigenvalues. Other values of s can also be used to suit particular applications.

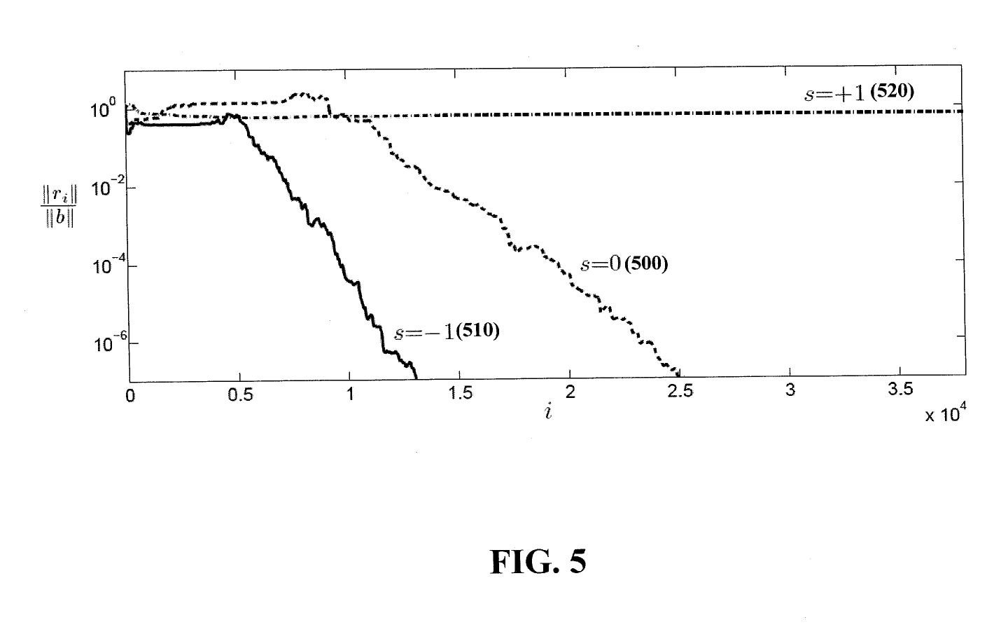

FIG. 5 shows an example convergence behavior of elimination of the high multiplicity of non-zero eigenvalues for different values of s, consistent with various embodiments of the present disclosure. This convergence behavior is shown for a metallic slot waveguide bend as for s=0 (500), −1 (510), +1 (520).

In addition to the above waveguide-based examples, various embodiments are directed to applications relating to other components such as multiplexers and photovoltaic cells. For instance, the propagation of optical waves can characterized using similar approaches in these devices, facilitating the convergence of simulation approaches.

Various embodiments are directed to addressing asymmetry in the operator in Equation 13, by manipulating Equation 14 to Equation 1 to derive an equation similar to Equation 13 with a symmetric operator:

$$∇ \times {μ}^{- 1} ∇ \times E + s ɛ ∇ [ {( {μɛ}^{2} )}^{- 1} ∇ \cdot ( ɛ E ) ] - {ω}^{2} ɛ E = iω J + s \frac{iɛ}{ω} ∇ [ {( {μɛ}^{2} )}^{- 1} ∇ \cdot J ] .$$

The convergence behavior of Equation 15 is similar to that of the convergence of Equation 13.

Various aspects of the present disclosure that are directed toward elimination of the high multiplicity of non-zero eigenvalues in solving a system of linear equations, are used in solving differential equations from which some sort of continuity equation is derived. For instance, the Navier-Stokes equations that describe the motion of fluid substances utilizing a continuity equation because it describes the transport of conserved energy. Additionally, certain aspects of the present disclosure that eliminate the high multiplicity of non-zero eigenvalues produce an operator that is similar to the Laplacian operator. Because a multigrid method is efficient for Laplacian, various aspects of the present disclosure can be used in implementing an efficient multigrid solver for the frequency-domain Maxwell's equations.

The various techniques of the present disclosure can be utilized alone or in combination to acceleration convergence of an iterative solver. The techniques described in the present disclosure each allow for interaction with the other techniques, for example, using convergence methods that are mathematically independent from the other methods (with no overlap or inconsistencies in the manner in which the techniques accelerate convergence of an iterative solver). For example, aspects of the present disclosure directed a preconditioning scheme tailored for UPML, and those directed toward modifying the non-symmetric coefficient matrix A into a symmetric matrix that is as well-conditioned as the original coefficient matrix A, both utilize preconditioning matrices to enhance the coefficient matrix. Each of these methods are independent from the aspects of the present disclosure directed toward elimination of the high multiplicity of non-zero eigenvalues in the coefficient matrix A, because this third method does not utilize preconditioning matrices, but alters the values within the coefficient matrix. Thus, by tailoring techniques relating to multiplying, symmetrizing and confining (e.g., as in modules 120, 125 and 135) to include no mathematic inconsistencies, a combination of two or all three of the techniques can be used to accelerate convergence of an iterative solver.

Certain aspects of the present disclosure are directed toward implementation of one or more of the techniques to accelerate convergence of an iterative solver, consistent with various embodiments of the present disclosure, in a matrix-free manner. For instance, the techniques can be represented and implemented in a matrix-free manner via utilization of diagonal preconditioners as discussed herein (e.g., in the multiplying and symmetrizing approaches), and modification of a differential operator itself (e.g., in confining). In certain embodiments, matrix-free implementation and its solving of a system of linear equations can be more memory-efficient than matrix-based implementation.

The techniques described in the present disclosure with reference to iterative methods can also be used to accelerate solving a system of linear equations using directed methods. For example, preconditioning a coefficient matrix as described herein can be used to achieve a better-conditioned matrix that contains fewer errors than a matrix that is not conditioned. Further, a symmetric matrix can be generated to occupy less memory than a non-symmetric matrix. Moreover, a matrix with less than near-zero eigenvalues can be generated to reduce the chance of the breakdown of such a matrix in the algorithms used in direct methods.

For further discussion of approaches to solving frequency-domain Maxwell's equations and the derivation of the aspects of the present disclosure (including those directed toward utilization of a uniaxial perfectly matched layer (UPML) boundary condition in solving a system of linear equations), and for example applications (e.g., waveguides) to which one or more embodiments herein may be applied, reference may be made to the published article Shin, Wonseok and Fan, Shanhui, “Choice of the perfectly matched layer boundary condition for frequency-domain Maxwell's equations solvers,” Journal of Computation Physics 231, pp. 3406-3441 (2012); which is, together with the references cited therein, herein fully incorporated by reference.

Various modules and/or other circuit-based building blocks may be implemented to carry out one or more of the operations and activities described herein and/or shown in the figures. In such contexts, a “module” is a circuit that carries out one or more of these or related operations/activities. For example, in certain of the above-discussed embodiments, one or more modules are discrete logic circuits or programmable logic circuits configured and arranged for implementing these operations/activities, as in the circuit modules shown in the Figures. In certain embodiments, the programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions. As another example such modules as shown in FIG. 1 may be embodied in stored instructions executed by a processor. Moreover, one or more of these embodiments may be carried out upon one or more different types of CPU circuits, such as in portable devices (e.g., for geophysical applications), lab-based computers, networks of computers and others. For instance, aspects of the present disclosure operate in conjunction with a graphics-processing unit (GPU). A GPU provides for computer power to execute one or more of the techniques, alone or in combination, consistent with various aspects of the present disclosure.

Certain embodiments are directed to a computer program product (e.g., nonvolatile memory device), which includes a machine or computer-readable medium having stored thereon instructions which may be executed by a computer (or other electronic device) to perform these operations/activities.

Based upon the above discussion and illustrations, those skilled in the art will readily recognize that various modifications and changes may be made to the present disclosure without strictly following the exemplary embodiments and applications illustrated and described herein. For example, the input terminals as shown and discussed may be replaced with terminals of different arrangements, and different types and numbers of input configurations (e.g., involving different types of input circuits and related connectivity). In addition, resistors of various values may be used in the input state detection circuits as shown and described, together with different values of Vdd, as relative to other resistors in the circuit and/or of the input circuits of which the resulting input pin state is to be evaluated. Such modifications do not depart from the true spirit and scope of the present disclosure, including that set forth in the following claims.

What is claimed is:

1. An apparatus for simulating a physical phenomenon characterized by a set of partial differential equations that are reduced based on harmonic time dependence, the apparatus comprising:
a data computing circuit having
stored therefor a system of linear equations representing an operation in the differential equations and in which a coefficient matrix is multiplied by an unknown column vector and with the product thereof being equal to a column vector, and
stored therein a program for executing an algorithm which, when executed, solves the system of linear equations, wherein the algorithm sets forth at least one of the following three sets of operations:
(i) multiplying the coefficient matrix by left and right scale-factor preconditioning matrices, and multiplying the column vector by the left scale-factor preconditioning matrix, each matrix including at least one of: entries of scale factors and combinations of scale factors of a perfectly matched layer,
(ii) symmetrizing the coefficient matrix by multiplying the coefficient matrix by left and right diagonally-dominant preconditioning matrices while maintaining a condition number of the coefficient matrix within an order of magnitude of a condition number of the matrix prior to symmetrizing, and
(iii) confining a majority of eigenvalues of the coefficient matrix in a half-plane having a boundary that crosses an origin of a complex plane.

2. The apparatus of claim 1, wherein the data computing circuit is configured and arranged to
receive data characterizing the physical phenomenon, and
use the program to execute the algorithm, using the received data as an input, to solve the system of linear equations and generate an output that characterizes the physical phenomenon.

3. The apparatus of claim 2, wherein the data computing circuit is configured and arranged to execute the algorithm to solve the linear equations by at least one of:
executing the algorithm with received electromagnetic wave data to solve the linear equations and generate an output that characterizes the behavior of the electromagnetic wave;
executing the algorithm with received optical wave data to solve the linear equations and generate an output that characterizes behavior of the optical wave;
executing the algorithm with received fluid dynamics system data to solve the linear equations and generate an output that characterizes behavior of the fluid dynamics system;
executing the algorithm with received chemical reaction data to solve the linear equations and generate an output that characterizes behavior of the chemical reaction; and
executing the algorithm with received mechanical system data to solve the linear equations and generate an output that characterizes behavior of the mechanical system.

4. The apparatus of claim 1, wherein the algorithm sets forth at least two of the sets of operations.

5. The apparatus of claim 1, wherein the algorithm sets forth all of the sets of operations.

6. The apparatus of claim 1, wherein the algorithm sets forth the operation of confining the majority of eigenvalues of the coefficient matrix in the half-plane, and thereafter, the operation of at least one of the steps of multiplying the coefficient matrix by the left and right scale-factor preconditioning matrices and symmetrizing the coefficient matrix.

7. The apparatus of claim 1, wherein symmetrizing the coefficient matrix includes preserving diagonal elements of the coefficient matrix.

8. The apparatus of claim 1, wherein multiplying the coefficient matrix by the left and right scale-factor preconditioning matrices includes utilizing the left and right scale-factor preconditioning matrices Pₗ and Pᵣ, in which:
$${P}_{l} = [ \begin{matrix}⋱ & & & & \\ & {s}_{y}^{j} {s}_{z}^{k} & & & \\ & & {s}_{z}^{k} {s}_{x}^{i} & & \\ & & & {s}_{x}^{i} {s}_{y}^{j} & \\ & & & & ⋱\end{matrix} ]$$
$${P}_{r} = [ \begin{matrix}⋱ & & & & \\ & 1 \text{/} {s}_{x}^{i + 1 \text{/} 2} & & & \\ & & 1 \text{/} {s}_{y}^{j + 1 \text{/} 2} & & \\ & & & 1 \text{/} {s}_{z}^{k + 1 \text{/} 2} & \\ & & & & ⋱\end{matrix} ] .$$

9. The apparatus of claim 1, wherein symmetrizing the coefficient matrix includes utilizing left and the right diagonally-dominant preconditioning matrices Pₗ and Pᵣ, in which:
$${P}_{l} = [ \begin{matrix}⋱ & & & & \\ & \frac{1}{\sqrt{\text{?} \text{?} \text{?}}} & & & \\ & & \frac{1}{\sqrt{\text{?} \text{?} \text{?}}} & & \\ & & & \frac{1}{\sqrt{\text{?} \text{?} \text{?}}} & \\ & & & & ⋱\end{matrix} ]$$
$${P}_{r} = [ \begin{matrix}⋱ & & & & \\ & \sqrt{\text{?} \text{?} \text{?}} & & & \\ & & \sqrt{\text{?} \text{?} \text{?}} & & \\ & & & \sqrt{\text{?} \text{?} \text{?}} & \\ & & & & ⋱\end{matrix} ] . \\ \text{?} \text{indicates text missing or illegible when filed}$$

10. The apparatus of claim 1, wherein confining a majority of eigenvalues of the coefficient matrix includes shifting eigenvalues, which are outside the half-plane, into the half-plane by modifying the coefficient matrix.

11. The apparatus of claim 10, wherein shifting eigenvalues includes one of:
shifting the eigenvalues so that at least 75% of the eigenvalues are in the half-plane,
shifting the eigenvalues so that at least 90% of the eigenvalues are in the half-plane, and
shifting the eigenvalues so that at least 95% of the eigenvalues are in the half-plane.

12. A method for simulating a physical phenomenon characterized by a set of partial differential equations that are reduced based on harmonic time dependence, the method comprising:
in a data computing circuit having stored therefor a system of linear equations representing an operation in the differential equations and in which a coefficient matrix is multiplied by an unknown column vector and with the product thereof being equal to a column vector, solving the system of linear equations by executing an algorithm that sets forth at least one of the following three sets of operations:
multiplying the coefficient matrix by left and right scale-factor preconditioning matrices, and multiplying the column vector b by the left scale-factor preconditioning matrix, each matrix including at least one of: entries of scale factors and combinations of scale factors of a perfectly matched layer,
symmetrizing the coefficient matrix by multiplying the coefficient matrix by left and right diagonally-dominant preconditioning matrices while maintaining a condition number of the coefficient matrix within an order of magnitude of a condition number of the matrix prior to symmetrizing, and
confining a majority of eigenvalues of the coefficient matrix in a half-plane having a boundary that crosses an origin of a complex plane.

13. The method of claim 12, further including, in the data computing circuit,
receiving data characterizing the physical phenomenon, and
executing the algorithm, using the received data as an input, to solve the system of linear equations and generate an output that characterizes the physical phenomenon.

14. The method of claim 13, wherein executing the algorithm includes at least one of:
executing the algorithm with received electromagnetic wave data to solve the linear equations and generate an output that characterizes the behavior of the electromagnetic wave;
executing the algorithm with received optical wave data to solve the linear equations and generate an output that characterizes behavior of the optical wave;
executing the algorithm with received fluid dynamics system data to solve the linear equations and generate an output that characterizes behavior of the fluid dynamics system;
executing the algorithm with received chemical reaction data to solve the linear equations and generate an output that characterizes behavior of the chemical reaction; and
executing the algorithm with received mechanical system data to solve the linear equations and generate an output that characterizes behavior of the mechanical system.

15. The method of claim 12, wherein solving the system of linear equations includes performing at least two of the operations.

16. The method of claim 12, wherein solving the system of linear equations includes performing all of the operations.

17. The method of claim 12, wherein executing the algorithm includes executing an algorithm that sets forth the operation of confining the majority of eigenvalues of the coefficient matrix in the half-plane, and thereafter, performing at least one of the operations of multiplying the coefficient matrix by the left and right scale-factor preconditioning matrices and symmetrizing the coefficient matrix.

18. The method of claim 12, wherein symmetrizing the coefficient matrix includes preserving diagonal elements of the coefficient matrix.

19. The method of claim 12, wherein multiplying the coefficient matrix by the left and right scale-factor preconditioning matrices includes utilizing the left and right scale-factor preconditioning matrices Pₗ and Pᵣ, in which:
$${P}_{l} = [ \begin{matrix}⋱ & & & & \\ & {s}_{y}^{j} {s}_{z}^{k} & & & \\ & & {s}_{z}^{k} {s}_{x}^{i} & & \\ & & & {s}_{x}^{i} {s}_{y}^{j} & \\ & & & & ⋱\end{matrix} ]$$
$${P}_{r} = [ \begin{matrix}⋱ & & & & \\ & 1 \text{/} {s}_{x}^{i + 1 \text{/} 2} & & & \\ & & 1 \text{/} {s}_{y}^{j + 1 \text{/} 2} & & \\ & & & 1 \text{/} {s}_{z}^{k + 1 \text{/} 2} & \\ & & & & ⋱\end{matrix} ] .$$

20. The method of claim 12, wherein symmetrizing the coefficient matrix includes utilizing left and the right diagonally-dominant preconditioning matrices Pₗ and Pᵣ, in which:
$${P}_{l} = [ \begin{matrix}⋱ & & & & \\ & \frac{1}{\sqrt{\text{?} \text{?} \text{?}}} & & & \\ & & \frac{1}{\sqrt{\text{?} \text{?} \text{?}}} & & \\ & & & \frac{1}{\sqrt{\text{?} \text{?} \text{?}}} & \\ & & & & ⋱\end{matrix} ]$$
$${P}_{r} = [ \begin{matrix}⋱ & & & & \\ & \sqrt{\text{?} \text{?} \text{?}} & & & \\ & & \sqrt{\text{?} \text{?} \text{?}} & & \\ & & & \sqrt{\text{?} \text{?} \text{?}} & \\ & & & & ⋱\end{matrix} ] . \\ \text{?} \text{indicates text missing or illegible when filed}$$

21. The method of claim 12, wherein confining a majority of eigenvalues of the coefficient matrix includes shifting eigenvalues, which are outside the half-plane, into the half-plane by modifying the coefficient matrix.

22. The method of claim 21, wherein shifting eigenvalues includes one of:
shifting the eigenvalues so that at least 75% of the eigenvalues are in the half-plane,
shifting the eigenvalues so that at least 90% of the eigenvalues are in the half-plane, and
shifting the eigenvalues so that at least 95% of the eigenvalues are in the half-plane.

23. An article of manufacture for simulating a physical phenomenon characterized by a set of partial differential equations that are reduced based on harmonic time dependence, comprising:
for execution by a processor having stored therefor a system of linear equations representing an operation in the differential equations and in which a coefficient matrix is multiplied by an unknown column vector and with the product thereof being equal to a column vector, a non-transitory processor-readable storage medium configured and arranged with program data that, when executed by the processor, causes the processor to solve the system of linear equations by at least one of:
multiplying the coefficient matrix by left and right scale-factor preconditioning matrices, and multiplying the column vector b by the left scale-factor preconditioning matrix, each matrix including entries of scale factors or combinations of scale factors of a perfectly matched layer,
symmetrizing the coefficient matrix by multiplying the coefficient matrix by left and right diagonally-dominant preconditioning matrices while maintaining a condition number of the coefficient matrix within an order of magnitude of a condition number of the matrix prior to symmetrizing, and
confining a majority of eigenvalues of the coefficient matrix in a half-plane having a boundary that crosses an origin of a complex plane.

24. The article of manufacture of claim 23, wherein the processor is configured and arranged to execute the algorithm to solve the linear equations by at least one of:
executing the algorithm with received electromagnetic wave data to solve the linear equations and generate an output that characterizes the behavior of the electromagnetic wave;
executing the algorithm with received optical wave data to solve the linear equations and generate an output that characterizes behavior of the optical wave;
executing the algorithm with received fluid dynamics system data to solve the linear equations and generate an output that characterizes behavior of the fluid dynamics system;
executing the algorithm with received chemical reaction data to solve the linear equations and generate an output that characterizes behavior of the chemical reaction; and
executing the algorithm with received mechanical system data to solve the linear equations and generate an output that characterizes behavior of the mechanical system.
